(19) United States
(12) Patent Application Publication
(10) Pub. No.: US 2018/0335996 A1
(43) Pub. Date: Nov. 22, 2018

(54) INFORMATION DISPLAY TECHNIQUES

(71) Applicant: CHIGOO (SHANGHAI) INTERACTIVE TECHNOLOGY CO., LTD., Shanghai (CN)

(72) Inventors: Tao Chen, Shanghai (CN); Ming Lei, Shanghai (CN)

(21) Appl. No.: 15/702,066

(22) Filed: Sep. 12, 2017

Related U.S. Application Data
(63) Continuation of application No. PCT/CN2017/089167, filed on Jun. 20, 2017.

(30) Foreign Application Priority Data
May 16, 2017 (CN) 201710347441.2

(51) Int. Cl. G06F 3/14; H04W 4/02

(52) U.S. Cl. CPC G06F 3/1423; G09G 2360/04; H04W 4/022; H04W 4/023

(57) ABSTRACT

Information display techniques are presented for public mobile devices deployed in different areas. The technique may include receiving, via a public mobile device, an information issuing table issued by a server; detecting information on a first position where the public mobile device is located; when a distance between the first location and a second known location is less than a predetermined distance threshold, counting a duration of how long the public mobile device resides within range of a predetermined distance threshold from the second known location; when the duration reaches a predetermined time threshold, sending, to the server, an information request; identifying an issuing destination matched with the address information according to the address information returned by the server; and acquiring the corresponding information content for display according to the screened issuing destination and the related information content ID.

### CROSS REFERENCE TO RELATED APPLICATIONS

This application is a continuation of International Application No. PCT/CN2017/089167, filed on Jun. 20, 2017, which is based upon and claims priority to Chinese Patent Application No. 201710347441.2, filed on May 16, 2017, the entire contents of each of which are incorporated herein by reference.

### TECHNICAL FIELD

The present application relates to the technical field of information delivery, and more particularly to an information resource display method and a public mobile device.

### BACKGROUND

A variety of positioning technologies have been developed, such as satellite positioning (GPS/BDS), radio frequency identification signal positioning/infrared identification signal positioning (RFID/IRID positioning), wireless local area network positioning (WLAN-AP), BLE Beacon positioning, LED white light positioning, geomagnetic field positioning and visual positioning signal-based positioning. Various schemes may be used for realizing instantaneous positioning information pushing using these positioning technologies. For example, based on the location of a mobile phone, relevant food and shopping information, etc., near a user's location can be pushed to the user. However, these technologies suffer from several drawbacks. For instance, the mobile phone in people's daily life plays many roles (such as personal assistant, social tools, office tools, entertainment tools, etc.), and therefore takes too many tasks and acquires numerous information resources every day. Thus, when the mobile phone serves as a pushing carrier for information resources, the information resources may become flooded in network information, resulting in some of the information resources often being ignored by mobile users. Not only that, since the mobile phone is a private device, whether to install certain applications and whether to use or watch certain applications are entirely based on the user's own decisions, so public information often does not possess the transmissibility to reach the audience. Therefore, the mobile phone is not suitable for some public places as an information display carrier. At the same time, for a portable mobile device, information resources are pushed based on the location of the mobile device itself, but the user's upcoming trip may not be predicted, and the information resources related to the trip may not be pushed.

Information may be displayed in a number of public places, such as airports, through large fixed electronic display screens, or display piles. Although these large electronic display screens or display piles can achieve information dissemination functionality to some extent, the dissemination effect is restrained due to their fixed locations. In addition, as large space resources are occupied by their large volumes, and public service standards limit their deployment, only a limited number of devices can be arranged for one boarding gate, and the devices at fixed locations are prone to be shielded by crowds, hence failing to effectively cover a large number of customers.

On the other hand, because the property rights, the operation rights, and the management rights of the airports belong to different entities, different airports, and even the same airport often purchases these large fixed electronic display screens or display piles in different periods of time, resulting in different hardware specifications and display capabilities of these display screens/display piles of each airport. Each airport then cooperates with selected information resource providers to obtain information resource pushing service functions. As a result, the display of information resources is restrained by the fields of different airports, different specifications of display equipment, and different cooperating resource providers, and it is difficult to display unified public information resources among a number of places (for example, in the whole city, in the whole province, in the whole country, or around the world). For example, due to restrictions from existing property rights, operation rights, management rights, fixed device specifications, and technical means, only information on a destination of a flight is broadcasted at a boarding gate of an airport from a certain starting place. On the contrary, it is impossible to synchronously broadcast information on the same destination at a boarding gate and via other locations such as other national or global airports. For example, using Shanghai as an example target city, conventional systems are limited in that tourism information on Shanghai cannot be synchronously displayed at boarding gates for flights to Shanghai at other nationwide or global airports.

### SUMMARY

The embodiments of the present invention relate to an information resource display method and a public mobile device for solving one or more of the problems present in the prior art.

As used herein, the term “information resources” may refer to any suitable type of data or information that is displayed, delivered, transmitted, or otherwise presented to a user. Thus, the term “information resource” or “information resources” may be considered synonymous with terms such as “data” or “information.”

Moreover, the terms “screened,” “screened out,” “screening out,” etc., as used herein, may refer to any suitable techniques used to identify, find out, or otherwise determine the relevant information that is described. For example, the public mobile device may identify an issuing destination matched with the address information from the information resource issuing table issued by the server. Thus, such screening terminology may be considered synonymous with ascertaining certain types of data and/or information.

According to a first aspect of the present invention, an information resource display method for public mobile devices is provided, which can be deployed in different areas, the method comprising the following steps:

receiving, by a public mobile device in an i-th area, an information resource issuing table issued by the server according to the i-th area, the information resource issuing table including at least: each piece of information content ID and an issuing destination related to the information content ID;

detecting, by the public mobile device, information on a first location at which the public mobile device is located;

when a distance between the first position location of the public mobile device and a known starting point in the i-th area as indicated by second position information is less than a predetermined distance threshold, counting a duration of the public mobile device residing within a radius range of the predetermined distance threshold from the starting point;

when the duration reaches a predetermined time threshold, transmitting, via the public mobile device, an information resource request to the server for requesting for address information on the at least one node in the at least one trip starting from the starting point, the information resource request including: information on the i-th area and the information on the starting point;

screening out, by the public mobile device, an issuing destination matched with the address information from the information resource issuing table according to the address information returned by the server; and

acquiring, by the public mobile device, the corresponding information content for display according to the screened (i.e., identified) issuing destination and the related information content ID associated with the identified issuing destination.

There is provided a public mobile device according to a second aspect of the present invention, comprising at least one processor, a wireless communication device capable of communicating with a server, at least one display and a memory. The memory may be configured to store one or more programs executable by the at least one processor, the programs being executed by the at least one processor such that the at least one processor and/or the public mobile device is capable of executing the above information resource display method.

### BRIEF DESCRIPTION OF THE DRAWINGS

In order to more clearly illustrate the embodiments of the present invention or the technical solutions in the prior art, the following drawings, which are to be used in the description of the embodiments or the prior art, are briefly described below.

FIG. 1 is a flowchart of an information resource display method, according to an embodiment of the present invention;

FIG. 2 is a flowchart of a method of returning, via a server, address information, according to an embodiment of the present invention;

FIG. 3 is a schematic structural drawing of the public mobile device, according to an embodiment of the present invention;

FIG. 4 is a structural schematic diagram for a handcart in an airport to realize simultaneous advertisement broadcasting, according to an embodiment of the present invention; and

FIG. 5 is a flowchart of advertisement broadcasting performed by the handcart in the airport, according to an embodiment of the present invention.

### DETAILED DESCRIPTION

In order to clarify the objective, technical solutions and advantages of embodiments of the present invention, the technical solutions in the embodiments of the present invention will be described below in conjunction with the drawings in the embodiments of the present invention. The described embodiments may be a part of embodiments of the present invention, in some cases, rather than all the embodiments. The embodiments described herein are done so by way of example, and additional or alternative embodiments may fall within the scope of the present invention based on the teachings of the present disclosure.

Embodiments of the present invention may be applied to a variety of large public places such as airports, railway stations and ports.

### Embodiment 1

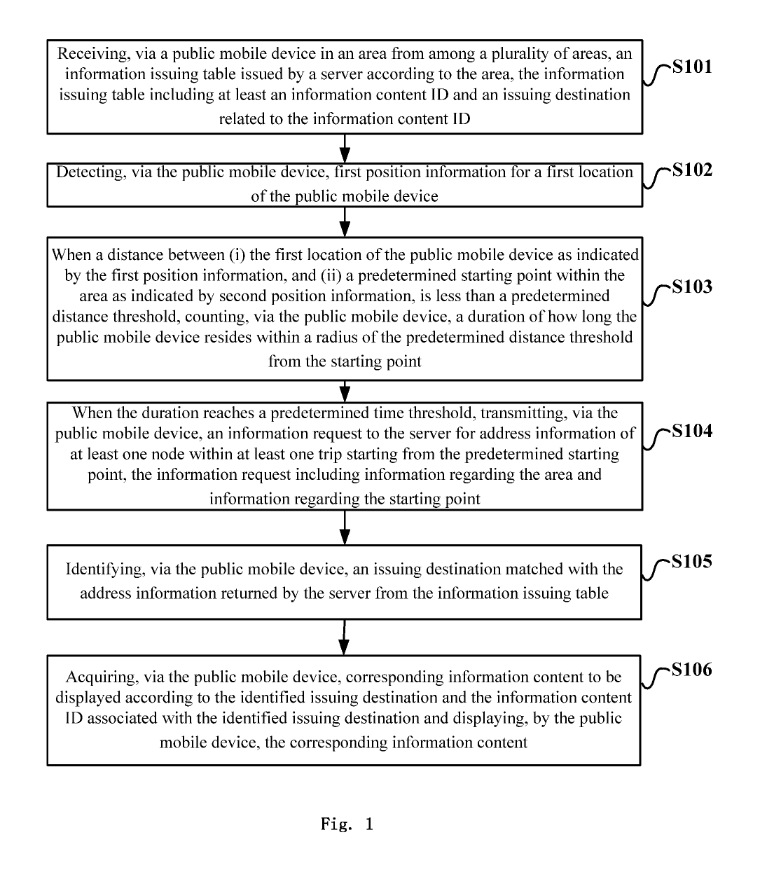

FIG. 1 is a flowchart of an information resource display method provided by an embodiment of the present invention for public mobile devices, which can be deployed in different areas. As shown in FIG. 1, the method, which may be executed by any suitable number of processors, public mobile devices, and/or servers, may comprise the following steps 101-106, for example, as further described below.

In step 101, the public mobile device in an i-th area may receive an information resource issuing table issued by the server according to the area in which the public mobile device is located, the information resource issuing table including at least each piece of information content ID, an issuing destination, and an issuing time period related to the information content ID.

In the present embodiment, the public mobile device is a public service facility provided to the public, such as a handcart in an airport, for example. Various public mobile devices can be deployed in different areas which may be for instance, in an airport, a city, a country, or across the whole world. The public mobile devices can move throughout these various areas. In addition, multiple public mobile devices may be deployed at the same time; for example, a plurality of handcarts may be deployed at different boarding gates in one airport.

In the present embodiment, the servers may be classified into first sub-servers and second sub-servers by function, with the first sub-server being configured to receive information resource requests from the public mobile devices deployed in different areas and to return corresponding results according to the information requests (i.e., the information resource requests) from the public mobile devices. The second sub-server may serve, for example, as a back-end server configured to receive an information resource issuing request from an information resource provider, and may be responsible for issuing and management of the information resources.

The second sub-servers (e.g., back-end servers) may be classified into central resource servers and area resource servers (e.g., airport resource servers) by function, in which the area resource server can be logically divided into one or more servers. The central resource server may review information resources provided by the information resource provider, and issue information resource data (including resource files) to the corresponding area resource server after the review is approved. Information items of the information resources may include, for instance, an information content ID, an information name, an information duration, an information resource agent name, an information resource provider name, an information issuing time period, an issuing area, an issuing destination, an information resource file, an information status, etc. The information resource status may include, for example, pending review, under review, disapproved, to-be-online, online, due offline, temporarily offline, etc.

After the information resources are issued, they may be cached to local internal storage spaces of one or more of (or all of) the public mobile devices in the public place according to the corresponding rules, which may include, for example the following.

1. With respect to the information resources that have been approved after review, the central resource server may issue information data (including resource files) to a corresponding area resource server.

2. The area resource server may distribute the information resources in the form of an information resource issuing table to one or more of (or all of) the public mobile devices located in the public place, and the public mobile devices may store the information resource issuing table in their respective local internal storage spaces. Information items in the information resource issuing table may include, for instance, an information content ID, an issuing destination, an issuing time period, an information duration, an information content status, etc.

Each time the information resource changes, including changes in review status, issuing status, issuing destination, information duration, issuing time period, information resource files, and/or other information, the above two steps may be repeated to ensure that the information content respectively stored in the central resource server, the area resource server, and the public mobile devices of the public place, are kept in sync.

In step 102, first position information (or, alternatively, first location information) for a first location of the public mobile device is detected.

In the present embodiment, a format of the first position information on the public mobile device may have various forms. For example, the first position information may be represented with three-dimensional geographical coordinates. The first location information can be via any suitable number and/or type of indoor and/or outdoor positioning techniques. For example, in the indoor environment of an airport, the positioning of the public mobile device can be implemented by adopting a variety of indoor techniques based on indoor map information (such as a terminal map) and a pre-laid indoor positioning network in the airport.

In step 103, when a distance between the first location of the public mobile device as indicated by the first position information, and a predetermined starting point within the area as indicated by second position information, is less than a predetermined distance threshold, the public mobile device counts a duration of how long it resides within a radius range of a predetermined distance threshold (e.g., centering on the predetermined starting point).

In the present embodiment, the second location information on the predetermined starting point can be stored in advance, for example, in a map database of the public mobile device. The format of the second position information on the predetermined starting point may be, for instance, the same as that of the first position information on the public mobile device, such as in the form of three-dimensional geographic coordinates, for example. In such a case, the distance value between the first location associated with the first position information and the second location associated with the second position information can be calculated. The predetermined distance threshold may be, in embodiments, a configurable distance value that is less than half of the minimum value of the distance between any two adjacent predetermined starting points. For example, if the distance between the two adjacent known starting points is 200 meters, then the predetermined distance threshold may be set to less than 100 meters.

In step 104, when the duration reaches a predetermined time threshold, the public mobile device transmits an information resource request to the server to request address information of at least one node in at least one trip starting from the predetermined starting point, the information resource request including the information regarding the i-th area (i.e., one of several areas) and information regarding the predetermined starting point.

In the present embodiment, the predetermined time threshold may be a configurable time length value. For example, the predetermined time threshold may be set by default to, for example, 10 minutes. The at least one node in the trip starting from the starting point may include a stop and a destination in this trip.

In step 105, an issuing destination matched with the address information may be screened out (i.e., identified) from the information resource issuing table according to the address information returned by the server.

In the present embodiment, the information resource issuing table may be a pre-stored information resource issuing table received from the server. The information resource issuing table may also be issued to the public mobile devices at any time if and when it is updated.

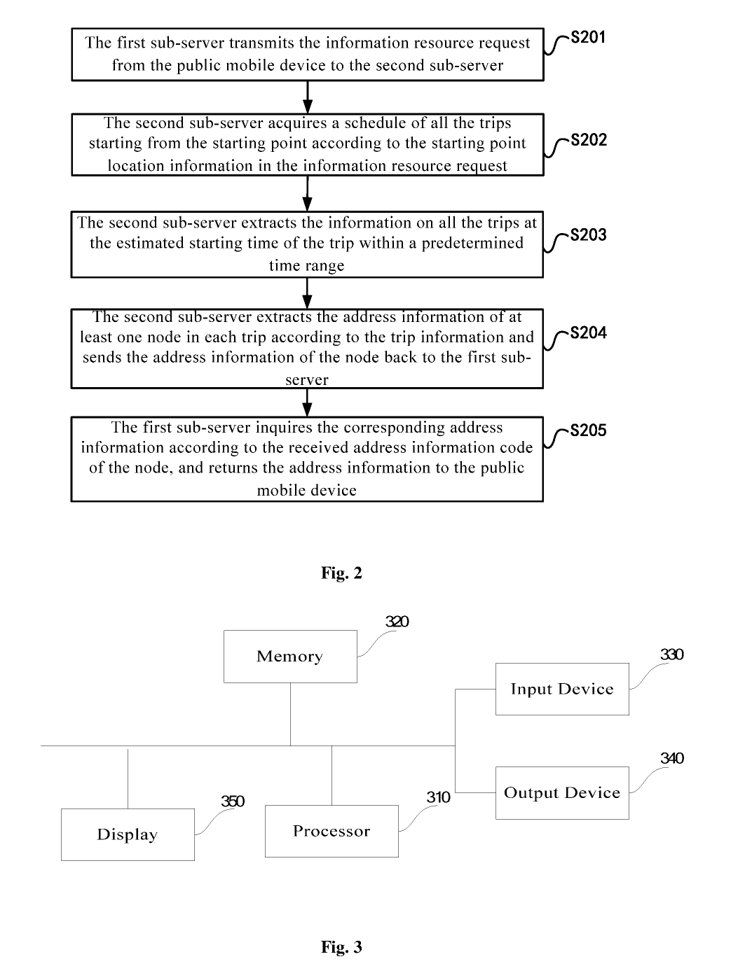

As shown in FIG. 2, the method, which may be executed by any suitable number of processors, public mobile devices, and/or servers, may comprise the following steps S201-205, for example, as further described below. With regards to the first and second sub-servers discussed below, this may include, for example, the first and second-sub servers having their respective functions, as discussed with respect to FIG. 1 and elsewhere herein.

In step S201, a first sub-server may transmit an information resource request received from the public mobile device to a second sub-server.

In step S202, the second sub-server may acquire a schedule of one or more (or all) the trips starting from the predetermined starting point according to the starting point location information in the information resource request.

In step S203, the second sub-server may extract information on one or more (or all) the trips at the estimated starting time of the trip within a predetermined time range.

In the present embodiment, the predetermined time range may be configured as desired as any suitable time period. For example, the predetermined time range may be set by default, for example, to the current day (i.e., the start time of the time range is 00:00:00 and the end time is 23:59:59 on the current day). With respect to a delayed trip in the trip schedule, if an estimated starting time of this trip has been allocated (i.e., the value of this field is non-empty), then an original estimated starting time of the trip may be calculated. If there is no estimated starting time of the trip within the predetermined time range, then a piece of trip information in which the estimated starting time is closest to the end time of the predetermined time range may instead be selected from the trip schedule.

In step S204, the second sub-server may extract the address information of at least one node in each trip according to the trip information, and send the address information of the node back to the first sub-server.

In step S205, the first sub-server may inquire the corresponding address information according to the received address information of the node, and return the corresponding address information to the public mobile device.

Referring back to FIG. 1, in step 106, the corresponding information content may be acquired for presentation according to the identified issuing destination and the related information content ID.

As an embodiment, the public mobile device may acquire the corresponding information content according to the screened issuing destination and the related information content ID, and display the information content within the corresponding issuing time period.

When the information server (e.g., the first or the second sub-server) cannot find the corresponding address information, the public mobile device can randomly select the information resources from a locally cached information resource list voluntarily, or the public mobile device may select the information resources in which the information issuing destination is not limited (ALL) from the local information resource list.

Thus, the embodiments described herein provide a technical solution to the problem that the existing display of information resources is restrained by property rights, operation rights, and management rights of information displayed in public places, and unified networking display of the information resources in a plurality of places (for example, in the whole city, in the whole province, in the whole country, around the world) is achieved.

Furthermore, compared with existing fixed display techniques, the present embodiments take into account location changes, and can make predictions based on the user's trip schedule to push information accordingly, thereby realizing more accurate display and dissemination of the information. Changes in the trip information may include a starting point change, trip cancellation, the end of the trip, etc. Moreover, by predicting the starting point of the public mobile device by locating the moving public mobile device, it is possible to realize accurate judgment of a user's upcoming trip, and to display information corresponding to the upcoming trip, such that the user can plan his/her activities better before he/she arrives.

In an alternative embodiment, the information resources may include an information content sequence including multiple pieces of information content, the method further comprising the following steps:

during the display of the information content sequence, op sequentially displaying information content such that information content in the information content sequence that has not yet been displayed is not displayed when the public mobile device determines that information on a trip starting from the starting point has changed;

sending another information resource request to the server to request address information of at least one node in the changed trip;

identifying a changed issuing destination matched with the changed address information returned by the server and related to the changed trip information from the information issuing table; and

acquiring the corresponding information content to be displayed according to the identified changed issuing destination and the information content ID associated with the identified changed issuing destination.

The information resources thus ensure that the content of the displayed information resources is up-to-date.

In an alternative embodiment, the public mobile device may also actively report the location information in accordance with any suitable schedule or time period, such as periodically (e.g., once every 60 second, 120 seconds, etc.). After receiving the information, the server may return the address information of a related node in the trip starting from the starting point according to the location information of the public mobile device.

In another alternative embodiment, the information content may include an information content sequence including multiple pieces of information content, and the method further include the following steps:

during the display of the information content sequence, stop sequentially displaying information content such that the information content that has not yet been displayed in the information content sequence is not displayed when detecting that a distance between third location of the public mobile device as indicated by third position information and the predetermined starting point within the area as indicated by second position information is greater than or equal to a predetermined distance threshold.

In this way, for a public mobile device leaving any known starting point, information on the starting point will no longer be pushed. After the trip finishes, the public mobile device may be, for instance, recycled by the maintenance personnel for use by other users. Therefore, the problem that a fixed display screen at a current public place constantly plays information even in the absence of crowds, which results in the waste of resources, is avoided.

In an alternative embodiment, the step of acquiring the corresponding information content according to the identified issuing destination and displaying the information content comprises downloading, via the public mobile device, the information related to the address information prior to displaying the information resources related to the address information.

In an alternative embodiment, the step of acquiring the corresponding information content according to the identified issuing destination and displaying the information content comprises steps of identifying, via the public mobile device, the information related to the address information from the locally cached information resources, and displaying the information resources. To improve the information display efficiency and prevent access to information resource files (pictures, video, etc.) from a resource server in a public place according to the information content ID for every display (which would require a large amount of bandwidth occupancy), the information resource files may be cached in the internal storage space of the public mobile device.

In an alternative embodiment, during the display of the information, the public mobile device may also insert information on a trip starting from the starting point. For example, after displaying a predetermined number of information content, the information on the trip starting from the starting point may be displayed on the public mobile device, with the predetermined number being a configurable parameter which may be any suitable number (e.g., five by default). After displaying the information content for a preset time period, the information content may then be continuously displayed. This the preset time period may be, for example, a configurable parameter (e.g., 30 seconds by default).

In addition, the public mobile device may simultaneously display the trip status information of several trips (e.g., 3 trips by default) which start from the starting point and whose starting time is closer to the planned starting time, and one piece of information resource content related to the node of one of the closest trips.

In this way, users during a trip can use more approaches to determine the current trip information, thus avoiding missing or delaying their trips.

In an alternative embodiment, the information content may include an information content sequence including multiple pieces of information content. The step of acquiring the corresponding information content according to the identified issuing destination and displaying the information content further comprises the following steps:

determining display progress information according to a synchronous control command acquired from the server, wherein the synchronous control command includes an information content ID to be displayed and a time stamp indicated a playing start time; and

selecting information content matched with the display progress information from the information content sequence.

In the present embodiment, the information content ID may be determined through an information content playing location returned from the synchronous control command issued by the server, and the time stamp indicated a playing start time may be the time at which the information content ID has been played.

In the present embodiment, the server may issue the synchronous control command while returning the address information of the at least one node in the at least one trip starting from the starting point.

In this way, the user may be exposed repeatedly to displayed information via screen synchronization, hence enhancing his memory of the information and thereby being more conducive to the dissemination of the information resources.

### Embodiment 2

A non-volatile computer storage medium storing computer-executable instructions is provided according to an embodiment. This non-volatile computer storage medium may include, for example, one or more portions of memory 320, as shown in FIG. 3 and further discussed herein. The computer-executable instructions may be used to implement the control method for information presentation of a public mobile device for any of the embodiments described herein, such as the various method embodiments mentioned above, for example.

As an implementation, the non-volatile computer storage medium in the present disclosure stores a computer-executable program for implementing the following operations: receiving, via a public mobile device in an i-th area (i.e., one of several areas), an information resource issuing table issued by a server according to the i-th area, the information resource issuing table at least including an information content ID and an issuing destination related to the information content ID;

detecting, via the public mobile device, first position information for a first location of the public mobile device;

when a distance between the first position information and second position information on a predetermined starting point in the i-th area is less than a predetermined distance threshold, counting, via the public mobile device, a duration of how long the public mobile device resides within a radius of the predetermined distance threshold from the starting point;

when the duration reaches the a predetermined time threshold, transmitting, via the public mobile device, an information resource request to the server for requesting for address information of at least one node in at least one trip starting from the predetermined starting point, the information resource request including: the information on the i-th area and the information on the predetermined starting point;

identifying, via the public mobile device, an issuing destination matched with the address information returned by the server from the information issuing table; and

acquiring, via the public mobile device, corresponding information content to be displayed according to the identified issuing destination and the information content ID associated with the identified issuing destination.

The non-volatile computer readable storage medium may be used to store a non-volatile software program, a non-volatile computer-executable program and module, such as the program instructions/modules corresponding to the control method for information resource presentation of a public mobile device in the embodiments of the present disclosure, for example. The one or more modules may be stored in the non-volatile computer readable storage medium, and when executed by the processor, perform any of the embodiments described herein, such as the various method embodiments mentioned above, for example.

The non-volatile computer readable storage medium may include any suitable number of storage areas, such as a program storage area and a data storage area. The program storage area may store an operating system and an application that performed one or more functions. The data storage area may store data and so on created according to the information resource presentation method. In addition, the non-volatile computer readable storage medium may include a high speed random access memory, and may also include a non-volatile memory, such as at least one magnetic disk storage device, a flash memory device, or other non-volatile solid-state storage devices. In some embodiments, the non-volatile computer readable storage medium may alternatively include a memory that is remote from the processor, which may be coupled to a control system for information resource presentation via a network. The examples of the above network may include, but are not limited to, for example, the Internet, an intranet, a local area network, a mobile communication network, etc., or any combinations thereof.

### Embodiment 3

FIG. 3 is a schematic diagram of a structure of the public mobile device, in accordance with an embodiment. The public mobile devices may be deployed in different areas and can move within and/or across areas. As shown in FIG. 3, the public mobile device may include one or more processors 310, a memory 320, and at least one display 350, wherein one processor 310 is taken as an example in FIG. 3.

In one embodiment of the present invention, the display 350 may include a public electronic display screen having a projection angle facing a public visual field. The public electronic display screen may be disposed at the front end of the public mobile device and away from the users, i.e. facing the public area, such that a front viewing effect is better achieved due to its slightly overlooking angle. The size of a public electronic display screen may be, for example, in a range between 15 inches to 40 inches, and preferably 27 inches.

In this way, a crowd approaching from the opposite side of the public mobile terminal may clearly see content displayed on the electronic display screen, allowing more people to see the content displayed on the electronic display screen.

In an alternative embodiment, the display 350 may further include a touchable interactive display screen having a projection angle facing a user of the public mobile device to provide one-to-one public services. The touchable interactive display screen and the outward-facing public electronic display screen may display the information resources simultaneously.

The public mobile device that presents information in accordance with the information resource display method may further include an input device 330 and an output device 340.

The processor 310, the memory 320, the input device 330, and the output device 340 may be connected via a bus or in any other suitable manner, although the connections shown in FIG. 3 implement a bus structure.

The memory 320 may employ the non-volatile computer readable storage medium of embodiment 2, for example. The processor 310 may include any suitable number and/or type of processors, and may implement various applications and data processing functions in conjunction with the server by operating non-volatile software programs, instructions, and modules stored in the memory 320 (i.e., to implement the information display method for the public mobile devices in the method embodiments described herein).

The input device 330 may receive input digit or character information and generate key signal inputs related to facilitate user settings and control functions of an inter- or multi-platform associated service system of the memory.

The above-described device public mobile device may execute one or more methods described in accordance with the embodiments presented herein, and thus may have corresponding function modules for executing the method, and may produce the aforementioned beneficial effects. The technical operation and other details associated with the public mobile device illustrated in FIG. 3 that are not described in detail in the present embodiment can be found in the description of the various methods discussed herein.

For the purpose of better understanding the present application by those skilled in the art, the solution of the present application will be further explained and described below in conjunction with specific application scenarios. These examples include how to deploy the public mobile devices (multimedia handcarts equipped with terminal devices) to a plurality of airports around the world. These scenarios are provided by way of example, and not by way of limitation.

It is assumed that an advertisement provider A requests to issue his/her advertisements to the Beijing Airport, the Shanghai Airport, and the New York Airport at the same time, and the advertisement provider A has an advertisement with an advertisement destination of Nanjing. An advertisement provider B requests to issue his/her advertisements to the Beijing Airport and the New York Airport, and the advertisement provider B has a piece of advertisement content with the issuing destinations of Shenzhen and Guangzhou. Airport servers may thus transmit an information resource issuing table corresponding to the airports to multimedia handcarts in the Beijing Airport, the Shanghai Airport, and the New York Airport, respectively, according to the differences of the airports issued by the advertisement provider A and the advertisement provider B. In this way, when the handcarts of these airports are pushed through different boarding gates, the advertisement information identical to the advertisement issuing destinations will be identified according to the destination address corresponding to the boarding gate, which is then played.

For example, when users may be waiting for flights in waiting halls of the Beijing Airport, the Shanghai Airport, and the New York Airport push their respective handcarts, an advertisement with the issuing destination of Nanjing from the advertisement provider A will be broadcasted in case that the handcarts are pushed to the boarding gate at which the destination or stop of the flight starting from this boarding gate is Nanjing. In this way, the purpose of displaying the advertisement from the advertisement provider A at the same time in the Beijing Airport, the Shanghai Airport, and the New York Airport in a unified manner is achieved.

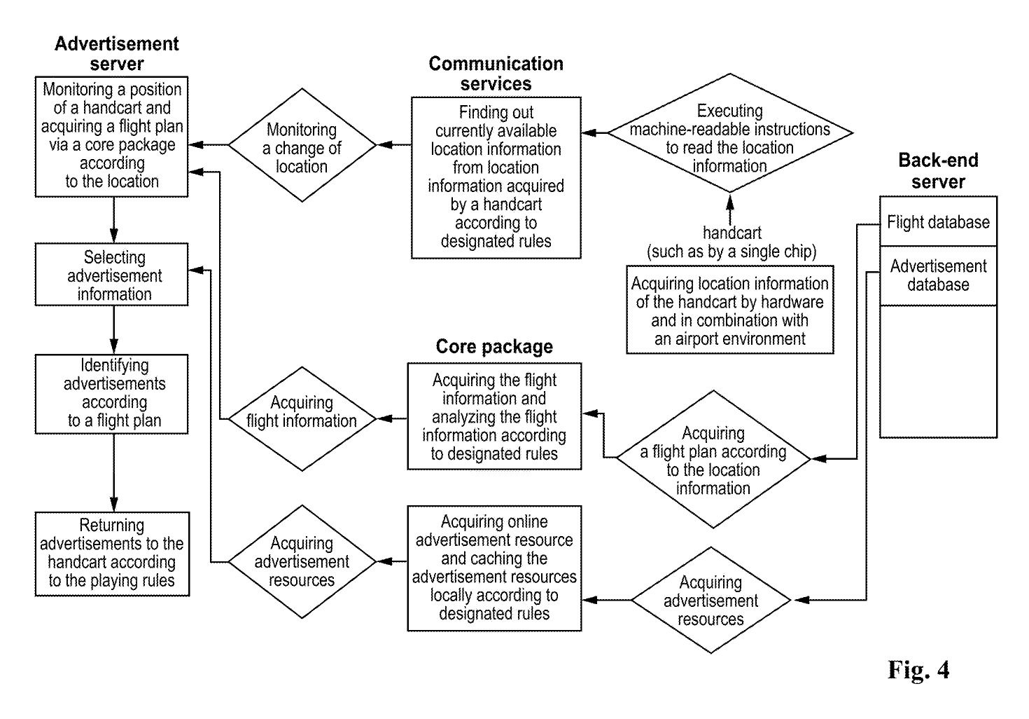

FIG. 4 is a schematic structural diagram for the handcart in the airport to achieve simultaneous advertisement broadcasting. The servers mainly include (or are logically classified into) advertisement servers as first servers and back-end servers as second servers. The back-end servers may be mainly used for the management of advertisement and flight information, and can be classified by function into central resource servers, airport servers, and flight servers, with the central resource servers and the airport servers being responsible for the maintenance and management of advertisement data. The advertisement servers may be responsible for monitoring the location changes of the handcarts, which may be detected by a single-chip processor mounted in or otherwise associated with the handcart, accepting advertisement requests from the handcarts, and returning the corresponding results according to the requests.

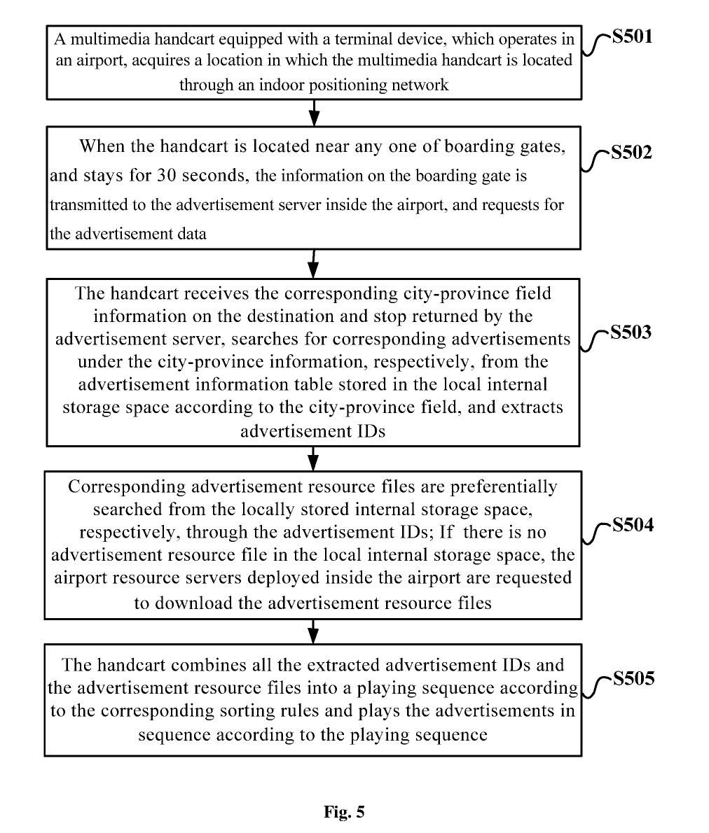

Further referring to FIG. 5, an illustrative example of a particular implementation of an embodiment of the information resource display method is provided, which includes the following steps S501-S505.

In S501, a multimedia handcart equipped with a terminal device, which operates in an airport, acquires a location in which the multimedia handcart is located through an indoor positioning network.

In S502, when the handcart is located near any one of boarding gates, and stays for a duration of 30 seconds (which may be timed by an internal timer, for instance), the information on the boarding gate (such as a boarding gate A100) is transmitted to the advertisement server inside the airport, and requests the advertisement data.

The advertisement server requests the flight server for the flight and destination airport information on the boarding gate on the current day through the boarding gate.

The flight server inquires a flight schedule in the time range of the current day and acquires airport three-letter codes (e.g., the airport three-letter codes that are allocated by the IATA (International Air Transport Association) in a unified manner) of the destination and stop(s) for each flight. Each airport has a unique three-letter code. The name of the airport, and information on the province, city, and country to which the airport belongs, may be inquired by means of this airport three-letter code.

The flight server sends the information on the three-letter airport code for the one or more destinations and stop(s) back to the advertisement server, and the advertisement server inquires a corresponding city-province field (when the destination airport is a US airport and the corresponding information is a city-state) through the respective general administrative division table, and returns the city-province field to the handcart.

In S503, the handcart terminal device receives the corresponding city-province field information on the destination and stop returned by the advertisement server, searches for the corresponding advertisements under the respective city-province information from the advertisement information table stored in the local internal storage space, and extracts the advertisement IDs.

The advertisement information table may be an advertisement information table correspondingly issued by the airport resource server according to different airports where the handcarts are located.

In S504, corresponding advertisement resource files are preferentially searched from the respective locally stored internal storage space using the advertisement IDs. If there is no advertisement resource file in the local internal storage space, the airport resource servers deployed inside the airport are requested to download the advertisement resource files.

In S505, the handcart combines all the extracted advertisement IDs and the advertisement resource files into a playing sequence according to the corresponding sorting rules, and plays the advertisements in sequence according to the sequence.

During the process of advertisement playing, if the handcart leaves the current boarding gate, enters a new area, and stays for a designated time, the steps S501-504 will be repeated.

During the process of advertisement playing, if there are flight changes in the following status (boarding gate change, cancellation, boarding end, takeoff, etc.) at the boarding gate in the flight schedule on the current day, the advertisements corresponding to the flight destination will be removed from the loop sequence. The flight schedule on the current day is required again, and a new advertisement cycle sequence is determined in sequence.

When the handcart is located near a designated boarding gate, the flight information corresponding to the boarding gate may also be displayed on a terminal screen of the handcart after each play of five advertisements during the advertisement playing process. The flight information is identical with data displayed on a flight display screen (a flight information display screen) near the boarding gate. After 30 seconds, the advertisements continue to be played.

### Technical Advantages

Compared with conventions systems, the above technical solution provided by the present invention has at least the following advantages.

The management and display of information resources are well integrated with the public mobile devices, and are not restrained by fields and display devices by the movement of the public mobile devices. It is a good solution to the problem that the existing display of information resources is retrained by property rights, operation rights, and management rights of information display in public places. The present invention thus makes it easier for the public mobile devices to be deployed in different areas for public use that may be delivered via hardware free of charge and/or in a low cost manner, such as in different sites in one public place, different places in one city, different cities in one country or any country on a global scale. Therefore, not only is the cost effectively reduced, but the restriction from the information resource display areas is removed, thereby achieving the dissemination of information resources on a global scale.

The public mobile device of the present invention may have a touch screen suitable for interactive use, and may provide one-to-one public services free of charge. These public services mainly include, for instance, rigid demand services, such as multi-language/mother tongue services, dynamic flight information, boarding reminders, indoor navigation, mobile phone charging, food and beverage recommendations, duty-free shopping guides, etc. These public services may also include, for instance, funny (interesting) content such as videos, games, and news; benefit gifts (for example, by watching videos, answering questionnaires, etc., passengers can receive coffee, cola and other beverages, or airport consumer coupons as a gift/gifts). This can also bring about advantages such as, for instance, airports and travelers preferring to use the public service mobile device to create the opportunity for the device to quickly enter global airports. Moreover, because of passenger preferences, the mobile device may be moved with the crowd (e.g., moved by people in an airport), so that the mobile devices are naturally gathered at a waiting gate where the crowd gathers, and therefore the information resource display conditions of the present invention is realized. For example, when a flight takes off, the mobile device may be collected by operation and maintenance personnel for use by other passengers. Therefore, the problem associated with a fixed display screen at a current boarding gate constantly playing information even in the absence of crowds (resulting in waste of resources), is avoided.

The public mobile device provided by the present invention may be designed for public places and thus function as a public facility for providing the public with free information services. Therefore, the public mobile device differs from a personal mobile device in that the type of information and the amount of information will not be excessive, and in doing so help ensure that the information displayed by the public mobile device may catch the public's attention more easily, thereby realizing more targeted and more effective display and dissemination of the information resources. Because personal privacy is not violated, the public mobile device is more suited to realizing the dissemination of the information than a personal mobile device. Secondly, since the display provided by the present invention has a larger electronic display screen, it may be viewed by many people at the same time, thereby facilitating the dissemination and display of the information.

The public mobile devices described herein may be deployed at a plurality of initial location points to be distributed in an initial target area. With the movement of these public mobile devices, the target area gradually becomes larger or is expanded, such that the information resources may be more effectively presented to the public. And even if some people do not use the public mobile devices, they can also see the information resources displayed at any time, thereby achieving wide audience coverage of the information resources, expanding the coverage of the information resources in an effective area, and improving the dissemination effect of the information resources. Moreover, compared with existing information display techniques that may be done by a fixed device at a fixed location, the presentation of information performed in accordance with the embodiments described herein via a public mobile device is unlikely to be shielded by a crowd and is more effective in covering a greater number of areas via its movement. In this way, the dissemination and display effects of the information of existing techniques are thus improved.

Compared with existing fixed display techniques, the present invention also takes into account the different locations of different users in the same area, can make predictions based on the user's trip schedule and push information accordingly, thereby realizing a more accurate display and dissemination of information. Additionally, by predicting the starting point of the public mobile device by positioning the same, it is possible to realize the relatively accurate judgment of the upcoming trip of the user, and to display information related to the upcoming trip of the user such that the user can plan his/her activities better before he/she arrives.

Moreover, the embodiments described herein may be implemented as part of one or more computer components, such as public mobile devices and/or one or more server components. As such, the embodiments described herein may be implemented as part of a computer network architecture that facilitates communications between various other devices and/or components. Thus, the embodiments described herein address and solve issues of a technical nature that are necessarily rooted in computer technology.

In doing so, the embodiments also address issues related to processing and resource usage by servers and/or public mobile devices. For example, by offloading the task of synchronization to servers in this manner, processing resources are conserved, allowing the public mobile devices to utilize less power. As a result, the embodiments described herein also help address issues related to controlling processing resources and regulating power usage.

The device embodiments described above are merely illustrative. Units described herein as being separate components may be or may not be separated physically. Components described as units may be or may not be physical units. For instance, various components or units described herein may be located at the same place, or may be distributed over a communication network or as several networked units. The solution achieved by each of the embodiments may thus be realized by selecting some or all modules, components, units, etc., according to actual needs.

By means of the description of the above implementations, those skilled in the art may clearly understand that various implementations may be realized by means of software plus any suitable hardware platform, and may also be realized by means of hardware. Based on such understanding, the essence of the above technical solution may be embodied as a software product stored in a computer-readable medium such as ROM/RAM, magnetic diskette, optical disc, etc., and comprising instructions for execution by a computer device (such as a personal computer, a server, or a network device) to implement the various methods in accordance with the various embodiments described herein, or parts thereof.

Finally, it should be noted that the above embodiments are merely provided for describing the technical solution of the present disclosure, but are not intended as a limitation. Although the present disclosure has been described in detail with reference to the embodiments, those skilled in the art will appreciate that the technical solution described in the various embodiments above can still be modified, or some technical features therein can be equivalently replaced. Such modifications or replacements do not make the essence of corresponding technical solutions depart from the spirit and scope of technical solutions embodiments of the present disclosure.

1. An information display method for public mobile devices which can be deployed in different areas, the method comprising:
receiving, via a public mobile device in an area from among a plurality of areas, an information issuing table issued by a server according to the area, the information issuing table including at least an information content ID and an issuing destination related to the information content ID;
detecting, via the public mobile device, first position information for a first location of the public mobile device;
when a distance between (i) the first location of the public mobile device as indicated by the first position information, and (ii) a predetermined starting point within the area as indicated by second position information is less than a predetermined distance threshold, counting, via the public mobile device, a duration of how long the public mobile device resides within a radius of the predetermined distance threshold from the starting point;
when the duration reaches a predetermined time threshold, transmitting, via the public mobile device, an information request to the server for address information of at least one node within at least one trip starting from the predetermined starting point, the information request including information regarding the area and information regarding the starting point;
identifying, via the public mobile device, an issuing destination matched with the address information returned by the server from the information issuing table;
acquiring, via the public mobile device, corresponding information content to be displayed according to the identified issuing destination and the information content ID associated with the identified issuing destination; and
displaying, by the public mobile device, the corresponding information content.

2. The method according to claim 1, wherein the information content includes an information content sequence including multiple pieces of information content, and wherein the act of displaying the corresponding information content further comprises:
when the public mobile device determines that information on a trip starting from the starting point has changed, to stop sequentially displaying information content such that information content in the information content sequence that has not yet been displayed is not displayed;
transmitting, via the public mobile device, another information resource request to the server to request address information of the at least one node in the changed trip;
identifying, via the public mobile device, a changed issuing destination matched with the changed address information returned by the server and related to the changed trip information from the information issuing table; and
acquiring, via the public mobile device, the corresponding information content to be displayed according to the identified changed issuing destination and the information content ID associated with the identified changed issuing destination.

3. The method according to claim 1, wherein the information content includes an information content sequence including multiple pieces of information content, and wherein the act of displaying the corresponding information content further comprises:
when the public mobile device detects that a distance between (i) a third location of the public mobile device as indicated by third position information, and (ii) the predetermined starting point within the area as indicated by second position information, is greater than or equal to the predetermined distance threshold, to stop sequentially displaying information content such that the information content that has not yet been displayed in the information content sequence is not displayed.

4. The method according to claim 1, wherein the act of acquiring the corresponding information content to be displayed comprises:
(i) downloading the information content according to the information content ID, or (ii) identifying the information content matched with the information content ID from a locally cached information content library.

5. The method according to claim 1, wherein the act of displaying the corresponding information content further comprises:
inserting, via the public mobile device, the information on a trip starting from the starting point while displaying the information content.

6. The method according to claim 1, wherein the information content includes an information content sequence including multiple pieces of information content, and
wherein the act of acquiring the corresponding information content further comprises:
determining display progress information according to a synchronous control command acquired from the server,
wherein the display progress information includes an information content ID to be displayed and a time stamp indicated a playing start time;
selecting information content matched with the display progress information from the information content sequence; and
synchronously displaying the information content.

7. A non-volatile computer storage medium for storing one or more computer executable programs, that when executed by at least one processor associated with a public mobile device, cause the public mobile device to:
receive, via the public mobile device in an area from among a plurality of areas, an information issuing table issued by a server according to the area, the information issuing table including at least an information content ID and an issuing destination related to the information content ID;
detect first position information for a first location of the public mobile device;
when a distance between (i) the first location of the public mobile device as indicated by the first position information, and (ii) a predetermined starting point within the area as indicated by second position information is less than a predetermined distance threshold, count a duration of how long the public mobile device resides within a radius of the predetermined distance threshold from the starting point;
when the duration reaches a predetermined time threshold, transmit an information request to the server for address information of at least one node within at least one trip starting from the predetermined starting point, the information request including information regarding the area and information regarding the starting point;
identify an issuing destination matched with the address information returned by the server from the information issuing table;
acquire corresponding information content to be displayed according to the identified issuing destination and the information content ID associated with the identified issuing destination; and
display the corresponding information content.

8. The non-volatile computer storage medium of claim 7, wherein the information content includes an information content sequence including multiple pieces of information content, and further including instructions that, when executed by the at least one processor, cause the public mobile device to:
display the corresponding information content by:
when the public mobile device determines that information on a trip starting from the starting point has changed, to stop sequentially displaying information content such that information content in the information content sequence that has not yet been displayed is not displayed;
transmitting another information resource request to the server to request address information of the at least one node in the changed trip;
identifying a changed issuing destination matched with the changed address information returned by the server and related to the changed trip information from the information issuing table; and
acquiring the corresponding information content to be displayed according to the identified changed issuing destination and the information content ID associated with the identified changed issuing destination.

9. The non-volatile computer storage medium of claim 7, wherein the information content includes an information content sequence including multiple pieces of information content, and further including instructions that, when executed by the at least one processor, cause the public mobile device to:
display the corresponding information content by:
when the public mobile device detects that a distance between (i) a third location of the public mobile device as indicated by third position information, and (ii) the predetermined starting point within the area as indicated by second position information, is greater than or equal to the predetermined distance threshold, to stop sequentially displaying information content such that the information content that has not yet been displayed in the information content sequence is not displayed.

10. The non-volatile computer storage medium of claim 7, further including instructions that, when executed by the at least one processor, cause the public mobile device to acquire the corresponding information content to be displayed by (i) downloading the information content according to the information content ID, or (ii) identifying the information content matched with the information content ID from a locally cached information content library.

11. The non-volatile computer storage medium of claim 7, further including instructions that, when executed by the at least one processor, cause the public mobile device to display the corresponding information content by inserting the information on a trip starting from the starting point while displaying the information content.

12. The non-volatile computer storage medium of claim 7, wherein the information content includes an information content sequence including multiple pieces of information content, and further including instructions that, when executed by the at least one processor, cause the public mobile device to acquire the corresponding information content further by:
determining display progress information according to a synchronous control command acquired from the server, wherein the display progress information includes an information content ID to be displayed and a time stamp indicated a playing start time;
selecting information content matched with the display progress information from the information content sequence; and
synchronously displaying the information content.

13. A public mobile device, comprising:
at least one processor;
a wireless communication device capable of communicating with a server;
at least one display; and
a memory, wherein the memory stores a program executable by the at least one processor, and the program is executed by the at least one processor to cause the public mobile device to:
receive, via the public mobile device in an area from among a plurality of areas, an information issuing table issued by a server according to the area, the information issuing table including at least an information content ID and an issuing destination related to the information content ID;
detect first position information for a first location of the public mobile device;
when a distance between (i) the first location of the public mobile device as indicated by the first position information, and (ii) a predetermined starting point within the area as indicated by second position information is less than a predetermined distance threshold, count a duration of how long the public mobile device resides within a radius of the predetermined distance threshold from the starting point;
when the duration reaches a predetermined time threshold, transmit an information request to the server for address information of at least one node within at least one trip starting from the predetermined starting point, the information request including information regarding the area and information regarding the starting point;
identify an issuing destination matched with the address information returned by the server from the information issuing table;
acquire corresponding information content to be displayed according to the identified issuing destination and the information content ID associated with the identified issuing destination; and
present, via the display, the corresponding information content.

14. The public mobile device of claim 13, wherein the information content includes an information content sequence including multiple pieces of information content, and wherein the at least one processor is further configured to cause the public mobile device to present, via the display, the corresponding information content by:
when the public mobile device determines that information on a trip starting from the starting point has changed, to stop sequentially displaying information content such that information content in the information content sequence that has not yet been displayed is not displayed;
transmitting another information resource request to the server to request address information of the at least one node in the changed trip;
identifying a changed issuing destination matched with the changed address information returned by the server and related to the changed trip information from the information issuing table; and
acquiring the corresponding information content to be presented according to the identified changed issuing destination and the information content ID associated with the identified changed issuing destination.

15. The public mobile device of claim 13, wherein the information content includes an information content sequence including multiple pieces of information content, and wherein the at least one processor is further configured to cause the public mobile device to present, via the display, the corresponding information content by:
when the public mobile device detects that a distance between (i) a third location of the public mobile device as indicated by third position information, and (ii) the predetermined starting point within the area as indicated by second position information, is greater than or equal to the predetermined distance threshold, to stop sequentially presenting information content such that the information content that has not yet been presenting in the information content sequence is not presenting.

16. The public mobile device of claim 13, wherein the at least one processor is further configured to cause the public mobile device to acquire the corresponding information content to be presenting by (i) downloading the information content according to the information content ID, or (ii) identifying the information content matched with the information content ID from a locally cached information content library.

17. The public mobile device of claim 13, wherein the at least one processor is further configured to cause the public mobile device to present, via the display, the corresponding information content by inserting the information on a trip starting from the starting point while displaying the information content.

18. The public mobile device of claim 13, wherein the information content includes an information content sequence including multiple pieces of information content, and wherein the at least one processor is further configured to cause the public mobile device to acquire the corresponding information content to be presented by:
determining display progress information according to a synchronous control command acquired from the server, wherein the display progress information includes an information content ID to be displayed and a time stamp indicated a playing start time;
selecting information content matched with the display progress information from the information content sequence; and
synchronously presenting the information content.

19. The public mobile device according to claim 13, wherein the at least one display comprises a public electronic display screen having a projection angle facing a public visual field.

20. The public mobile device according to claim 19, wherein the at least one display further comprises a touchable interactive display screen having a projection angle facing a user of the public mobile device.
